(19) United States
(12) Patent Application Publication
(10) Pub. No.: US 2007/0161755 A1
(43) Pub. Date: Jul. 12, 2007

(54) Additives for low-sulfur mineral oil distillates, comprising graft copolymers based on ethylene-vinyl acetate copolymers

(75) Inventors: Bettina Siggelkow, Frankfurt am Main (DE); Waltraud Nagel, Oberhausen (DE); Ulrike Neuhaus, Oberhausen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 11/652,286

(22) Filed: Jan. 11, 2007

(30) Foreign Application Priority Data
Jan. 11, 2006 (DE) 102006001380.8

(51) Int. Cl. C08F 297/02

(52) U.S. Cl. 525/242

(57) ABSTRACT

The invention provides graft copolymers obtainable by grafting an ester (a) of a C₈- to C₂₂-alcohol and acrylic acid onto a copolymer (b) containing, in addition to ethylene, from 3.5 to 21 mol % of vinyl acetate and from 0.5 to 16 mol % of at least one vinyl ester of the formula 1
CH₂═CH—OCOR¹ (1)
where R¹ is C₂- to C₃₀-alkyl, with the proviso that the copolymer b) contains less than 0.5 mol % of alkenes having 3 to 30 carbon atoms.

The invention relates to additives for low-sulfur mineral oil distillates having improved cold flowability and paraffin dispersancy, comprising a graft copolymer, to fuel oils additized with them and to the use of the additive.

In view of the decreasing mineral oil reserves coupled with steadily rising energy demand, ever more problematic crude oils are being extracted and processed. In addition, the demands on the fuel oils produced therefrom, such as diesel and heating oil, are becoming ever more stringent, not least as a result of legislative requirements. Examples thereof are the reduction in the sulfur content and the limitation of the final boiling point and also of the aromatics content of middle distillates, which force the refineries into constant adaptation of the processing technology. In middle distillates, this leads in many cases to an increased proportion of paraffins, especially in the chain length range of from C₁₈ to C₂₄, which in turn has a negative influence on the cold flow properties of these fuel oils.

Crude oils and middle distillates, such as gas oil, diesel oil or heating oil, obtained by distillation of crude oils contain, depending on the origin of the crude oils, different amounts of n-paraffins which crystallize out as platelet-shaped crystals when the temperature is reduced and sometimes agglomerate with the inclusion of oil. This crystallization and agglomeration causes a deterioration in the flow properties of these oils or distillates, which may result in disruption in the course of extraction, transport, storage and/or use of the mineral oils and mineral oil distillates. When mineral oils are transported through pipelines, the crystallization phenomenon can, especially in winter, lead to deposits on the pipe walls, and in individual cases, for example in the event of stoppage of a pipeline, even to its complete blockage. When the mineral oils are stored and processed further, it may also be necessary in winter to store the mineral oils in heated tanks. In the case of mineral oil distillates, the consequence of crystallization may be blockages of the filters in diesel engines and boilers, which prevents reliable metering of the fuels and under some circumstances results in complete interruption of the fuel or heating medium feed.

In addition to the classical methods of eliminating the crystallized paraffins (thermally, mechanically or using solvents), which merely involve the removal of the precipitates which have already formed, chemical additives (known as flow improvers) have been developed in recent years. By interacting physically with the precipitating paraffin crystals, they bring about modification of their shape, size and adhesion properties. The additives function as additional crystal seeds and some of them crystallize out with the paraffins, resulting in a larger number of smaller paraffin crystals having altered crystal shape. The modified paraffin crystals have a lower tendency to agglomerate, so that the oils admixed with these additives can still be pumped and processed at temperatures which are often more than 20° C. lower than in the case of nonadditized oils.

Typical flow improvers for crude oils and middle distillates are co- and terpolymers of ethylene with carboxylic esters of vinyl alcohol.

A further task of flow improver is the dispersion of the paraffin crystals, i.e. the retardation or prevention of the sedimentation of the paraffin crystals and therefore the formation of a paraffin-rich layer at the bottom of storage vessels.

The prior art also discloses certain graft copolymers which are added to middle distillates as cold additives.

DE-A-37 25 059 discloses flow improvers based on graft polymers of polyalkyl methacrylates to ethylene-vinyl ester copolymers, containing
a) 20-80% by weight of alkyl methacrylate having 8-1.5 carbon atoms in the ester alkyl radical and
b) 80-20% by weight of ethylene-vinyl acetate copolymers, preferably having 28-40% by weight of vinyl acetate, where the original viscosity of the ethylene-vinyl acetate copolymers η spec/c (at 25° C. in xylene) is preferably 6-50 ml/g, in particular 6-30 ml/g, and where the degree of branching is preferably from 3 to 15 CH₃ groups per 100 CH₂ groups and
c) a solvent S having a boiling point of at least 50° C., preferably >100° C., at pressure (1013 hPa/760 mm).

U.S. Pat. No. 4,608,411 discloses copolymers of ethylene and vinyl acetate, onto which acrylates are grafted, and the use thereof as a cold additive for fuel oils.

The above-described flow-improving and/or paraffin-dispersing action of the prior art paraffin dispersants is not always sufficient, so that, on cooling of the oils, large paraffin crystals sometimes form and lead to filter blockages and, owing to their higher density, sediment in the course of time and thus lead to the formation of a paraffin-rich layer at the bottom of storage vessels. Problems occur in particular in the additization of paraffin-rich and narrow-cut distillation cuts having boiling ranges of 20-90% by volume of less than 120° C., in particular less than 100° C. The situation is particularly problematic in the case of low-sulfur winter qualities having cloud points below −5° C.; here, the addition of existing additives often cannot achieve sufficient paraffin dispersancy.

It is therefore an object of the invention to improve the flowability and in particular the paraffin dispersancy under cold conditions for mineral oils and mineral oil distillates by the addition of suitable cold additives.

It has now been found that, surprisingly, a cold additive which comprises graft copolymers which are obtainable by grafting alkyl acrylates to ethylene-vinyl acetate-alkene copolymers has distinctly better suitability for paraffin dispersancy than the prior art graft copolymers.

The invention thus provides a graft copolymer obtainable by grafting an ester (a) of a C₈- to C₂₂-alcohol and acrylic acid onto a copolymer (b) containing, in addition to ethylene, from 3.5 to 21 mol % of vinyl acetate and from 0.5 to 16 mol % of at least one vinyl ester of the formula 1
CH₂═CH—OCOR¹ (1)
where R¹ is C₂- to C₃₀-alkyl, with the proviso that the copolymer b) contains less than 0.5 mol % of alkenes having 3 to 30 carbon atoms.

The graft copolymers thus obtained preferably have a molecular weight (Mn) between 1000-10 000 g/mol, in particular between 1500-8000 g/mol.

The invention further provides middle distillate fuel oils which comprise the above-described graft copolymer.

The invention further provides for the use of the above-described graft copolymers as paraffin dispersants in fuel oils, preferably in middle distillates.

The invention further provides a process for improving the cold flow properties of fuel oils, comprising the addition of the above-defined graft copolymers to the fuel oil.

In the vinyl esters of the formula 1, R¹ is preferably C₄- to C₁₆-alkyl, especially C₆- to C₁₂-alkyl. In a further embodiment, the alkyl groups mentioned may be substituted by one or more hydroxyl groups. The copolymer b) may contain more than one vinyl ester of the formula 1.

In a further preferred embodiment, R¹ is a branched alkyl radical or a neoalkyl radical having from 7 to 11 carbon atoms, in particular having 8, 9 or 10 carbon atoms. Particularly preferred vinyl esters derive from secondary and especially tertiary carboxylic acids whose branch is in the alpha-position to the carbonyl group. Suitable vinyl esters include vinyl propionate, vinyl butyrate, vinyl isobutyrate, vinyl hexanoate, vinyl heptanoate, vinyl octanoate, vinyl pivalate, vinyl 2-ethylhexanoate, vinyl laurate, vinyl stearate and Versatic esters such as vinyl neononanoate, vinyl neodecanoate, vinyl neoundecanoate.

The ethylene copolymers suitable as the copolymer (b) for the grafting are in particular those which contain 7.5-15 mol % of vinyl acetate.

These copolymers preferably have melt viscosities at 140° C. of from 20 to 10 000 mPas, in particular from 30 to 5000 mPas, especially from 50 to 2000 mPas.

The ethylene copolymers suitable as the copolymer (b) for the grafting preferably have a molecular weight distribution M_{w}/Mₙ of from 1 to 10, in particular from 1.5 to 4.

The ethylene copolymers suitable as the copolymer (b) for the grafting may contain, in addition to vinyl acetate and at least one vinyl ester of the formula 1, up to 16 mol %, preferably from 1 to 15 mol %, especially from 2 to 10 mol %, of further olefinically unsaturated monomers different therefrom, but less than 0.5 mol % of alkenes having from 3 to 30 carbon atoms. These olefinically unsaturated monomers are preferably vinyl esters, acrylic esters, methacrylic esters and/or alkyl vinyl ethers, and the compounds mentioned may be substituted by hydroxyl groups. One or more of these comonomers may be present in the copolymer.

The acrylic esters are preferably those of the formula 2
CH₂═CR²—COOR³ (2)
where R² is hydrogen or methyl and R³ is C₁- to C₃₀-alkyl, preferably C₄- to C₁₆-alkyl, especially C₆- to C₁₂-alkyl. Suitable acrylic esters include, for example, methyl (meth)acrylate, ethyl (meth)acrylate, propyl (meth)acrylate, n- and isobutyl (meth)acrylate, hexyl, octyl, 2-ethylhexyl, decyl, dodecyl, tetradecyl, hexadecyl, octadecyl (meth)acrylate and mixtures of these comonomers. In a further embodiment, the alkyl groups mentioned may be substituted by one or more hydroxyl groups. An example of such an acrylic ester is hydroxyethyl methacrylate.

The alkyl vinyl ethers are preferably compounds of the formula 3
CH₂═CH—OR⁴ (3)
where R⁴ is C₁- to C₃₀-alkyl, preferably C₄- to C₁₆-alkyl, especially C₆- to C₁₂-alkyl. Examples include methyl vinyl ether, ethyl vinyl ether, isobutyl vinyl ether. In a further embodiment, the alkyl groups mentioned may be substituted by one or more hydroxyl groups.

Apart from ethylene, particularly preferred terpolymers contain from 0.1 to 12 mol %, in particular from 0.2 to 10 mol %, of vinyl neononanoate or of vinyl neodecanoate, and from 3.5 to 21 mol %, in particular from 8 to 15 mol %, of vinyl acetate, the total comonomer content being between 8 and 21 mol %, preferably between 12 and 18 mol %.

The graft component a) is alkyl esters of acrylic acid having 8-22 carbon atoms, in particular having 10-15 carbon atoms, in the alkyl radical. It may be isoalkyl or else n-alkyl esters. Especially preferred are the iso-C₁₀-alkyl acrylates and the C₁₂-C₁₄-alkyl acrylates. The alkyl esters of acrylic acid may also be grafted on in a mixture.

The weight ratio of graft component a) to base polymer b) is preferably from 1:4 to 4:1, in particular from 1:1 to 3:1. The grafting reaction is preferably carried out as follows. The base polymer is initially charged in a suitable polymerization vessel and a solvent, for example dissolved in kerosene. The amount of the solvent S used depends upon the nature thereof. The dissolution can be promoted by heating, for example to 90±10° C., with stirring. Thereafter, advantageously at elevated temperature taking into account the decomposition temperatures of the initiators used, for instance up to 90° C. and under a protective gas such as nitrogen or argon, the monomers and an initiator are metered in, for example in a mixture, advantageously by means of a metering pump and within a certain period, for example 2±½ hours. Useful initiators include the free-radical initiators customary per se, in particular per compounds such as peresters, e.g. tert-butyl peroctoate. In general, the addition of the initiators is in the range from 0.5 to 5% by weight, preferably 1-4% by weight, based on the monomers.

Advantageously, initiator is added once again at the end of the feeding, for instance approx. 15% by weight of the amount already used. The total polymerization time is about 8-16 hours.

Any homopolymer formed in the polymerization of a) can generally remain in the batch which can thus be used further as it is, i.e. without specific purification.

The inventive graft copolymers are added to middle distillates preferably in amounts of from 10 to 500 ppm.

The inventive graft copolymers may be used as such. They may also be present and used in the form of additive compositions which, in addition to the inventive graft copolymers, comprise one or more further constituents as coadditives. These additive compositions are referred to hereinbelow as inventive additives.

In a preferred embodiment, the inventive additives comprise alkylphenol-aldehyde resins as a further constituent (constituent II). Alkylphenol-aldehyde resins are known in principle and are described, for example, in Römpp Chemie Lexikon, 9th edition, Thieme Verlag 1988-92, volume 4, p. 3351 ff. Suitable in accordance with the invention are in particular those alkylphenol-aldehyde resins which derive from alkylphenols having one or two alkyl radicals in the ortho- and/or para-position to the OH group. Particularly preferred starting materials are alkylphenols which bear, on the aromatic ring, at least two hydrogen atoms capable of condensation with aldehydes, and especially monoalkylated phenols whose alkyl radical is in the para-position. The alkyl radicals (for constituent I, this refers generally to hydrocarbon radicals as defined below) may be the same or different in the alkylphenol-aldehyde resins usable in the process according to the invention, they may be saturated or unsaturated and have 1-200, preferably 1-20, in particular 4-12 carbon atoms; they are preferably n-, iso- and tert-butyl, n- and isopentyl, n- and isohexyl, n- and isooctyl, n- and isononyl, n- and isodecyl, n- and isododecyl, tetradecyl, hexadecyl, octadecyl, tripropenyl, tetrapropenyl, poly(propenyl) and poly(isobutenyl) radicals.

Suitable aldehydes for the alkylphenol-aldehyde resins are those having from 1 to 12 carbon atoms and preferably those having from 1 to 4 carbon atoms, for example formaldehyde, acetaldehyde, propionaldehyde, butyraldehyde, 2-ethylhexanal, benzaldehyde, glyoxalic acid and reactive equivalents thereof, such as paraformaldehyde and trioxane. Particular preference is given to formaldehyde in the form of paraformaldehyde and especially formalin.

All molecular weights were measured by means of gel permeation chromatography (GPC) against polystyrene standards in THF.

The molecular weight of the alkylphenol-aldehyde resins is preferably 400-20 000 g/mol, especially 400-5000 g/mol. A prerequisite in this context is that the alkylphenol-aldehyde resins are oil-soluble at least in concentrations relevant to the application of from 0.001 to 1% by weight.

In a preferred embodiment of the invention, the alkylphenol-formaldehyde resins contain oligo- or polymers having a repeat structural unit of the formula 4 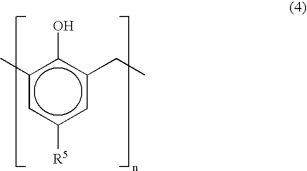
where R⁵ is C₁-C₂₀₀-alkyl or -alkenyl and n is from 2 to 100. R⁵ is preferably C₄-C₂₀-alkyl or -alkenyl and especially C₆-C₁₆-alkyl or -alkenyl. n is preferably from 2 to 50 and especially from 3 to 25, for example from 5 to 15.

For use in middle distillates such as diesel and heating oil, particular preference is given to alkylphenol-aldehyde resins having C₂-C₄₀-alkyl radicals of the alkylphenol, preferably having C₄-C₂₀-alkyl radicals, for example C₆-C₁₂-alkyl radicals. The alkyl radicals may be linear or branched; they are preferably linear. Particularly suitable alkylphenol-aldehyde resins derive from linear alkyl radicals having 8 and 9 carbon atoms. The average molecular weight, determined by means of GPC, is preferably between 700 and 20 000, in particular between 800 and 10 000, for example between 1000 and 2500 g/mol.

These alkylphenol-aldehyde resins are obtainable by known processes, for example by condensation of the appropriate alkylphenols with formaldehyde, i.e. with from 0.5 to 1.5 mol, preferably from 0.8 to 1.2 mol, of formaldehyde per mole of alkylphenol. The condensation may be effected without solvent, but is preferably effected in the presence of a water-immiscible or only partly water-miscible inert organic solvent such as mineral oils, alcohols, ethers and the like. Particular preference is given to solvents which can form azeotropes with water. Useful such solvents are in particular aromatics such as toluene, xylene, diethylbenzene and relatively high-boiling commercial solvent mixtures such as ®Shellsol AB and Solvent Naphtha. The condensation is effected preferably between 70 and 200° C., for example between 90 and 160° C. It is catalyzed typically by from 0.05 to 5% by weight of bases or acids.

The mixing ratio of the alkylphenol-aldehyde resins as a coadditive to the inventive graft copolymers is generally between 20:1 and 1:20, preferably between 1:10 and 10:1.

In a preferred embodiment, the inventive additives for middle distillates comprise, in addition to the graft copolymer, one or more copolymers of ethylene and olefinically unsaturated compounds as constituent Ill. Suitable ethylene copolymers are in particular those which, in addition to ethylene, contain from 6 to 21 mol %, in particular from 10 to 18 mol %, of comonomers. These copolymers preferably have melt viscosities at 140° C. of from 20 to 10 000 mPas, in particular from 30 to 5000 mPas, especially from 50 to 2000 mpas.

In a preferred embodiment, the copolymers are of ethylene and from 6 to 21 mol % of unsaturated esters. Preferred unsaturated esters are the vinyl esters of C₂ to C₁₂ carboxylic acids. In a further preferred embodiment, the copolymer comprises, in addition to ethylene, from 3.5 to 20 mol % of a vinyl ester of a C₂ to C₄ carboxylic acid and from 0.1 to 12 mol % of a C₆ to C₁₂ carboxylic acid, where the total content of vinyl ester is from 6 to 21 mol %, preferably from 10 to 18 mol %.

The olefinically unsaturated compounds are preferably vinyl esters, acrylic esters, methacrylic esters, alkyl vinyl ethers and/or alkenes, and the compounds mentioned may be substituted by hydroxyl groups. One or more comonomers may be present in the polymer.

The vinyl esters are preferably those of the formula 5
CH₂═CH—OCOR¹ (5)
where R¹ is C₁- to C₃₀-alkyl, preferably C₄- to C₁₆-alkyl, especially C₆- to C₁₂-alkyl. In a further embodiment, the alkyl groups mentioned may be substituted by one or more hydroxyl groups.

In a further preferred embodiment, R¹ is a branched alkyl radical or a neoalkyl radical having from 7 to 11 carbon atoms, in particular having 8, 9 or 10 carbon atoms. Particularly preferred vinyl esters derive from secondary and especially tertiary carboxylic acids whose branch is in the alpha-position to the carbonyl group. Suitable vinyl esters include vinyl acetate, vinyl propionate, vinyl butyrate, vinyl isobutyrate, vinyl hexanoate, vinyl heptanoate, vinyl octanoate, vinyl pivalate, vinyl 2-ethylhexanoate, vinyl laurate, vinyl stearate and Versatic esters such as vinyl neononanoate, vinyl neodecanoate, vinyl neoundecanoate.

In a further preferred embodiment, these ethylene copolymers contain vinyl acetate and at least one further vinyl ester of the formula 5 where R¹ is C₄- to C₃₀-alkyl, preferably C₄- to C₁₆-alkyl, especially C₆- to C₁₂-alkyl.

The acrylic esters are preferably those of the formula 6
CH₂═CR²—COOR³ (6)
where R² is hydrogen or methyl and R³ is C₁- to C₃₀-alkyl, preferably C₄- to C₁₆-alkyl, especially C₆- to C₁₂-alkyl. Suitable acrylic esters include, for example, methyl (meth)acrylate, ethyl (meth)acrylate, propyl (meth)acrylate, n- and isobutyl (meth)acrylate, hexyl, octyl, 2-ethylhexyl, decyl, dodecyl, tetradecyl, hexadecyl, octadecyl (meth)acrylate and mixtures of these comonomers. In a further embodiment, the alkyl groups mentioned may be substituted by one or more hydroxyl groups. An example of such an acrylic ester is hydroxyethyl methacrylate.

The alkyl vinyl ethers are preferably compounds of the formula 7
CH₂═CH—OR⁴ (7)
where R⁴ is C₁- to C₃₀-alkyl, preferably C₄- to C₁₆-alkyl, especially C₆- to C₁₂-alkyl. Examples include methyl vinyl ether, ethyl vinyl ether, isobutyl vinyl ether. In a further embodiment, the alkyl groups mentioned may be substituted by one or more hydroxyl groups.

The alkenes are preferably monounsaturated hydrocarbons having from 3 to 30 carbon atoms, in particular from 4 to 16 carbon atoms and especially from 5 to 12 carbon atoms. Suitable alkenes include propene, butene, isobutylene, pentene, hexene, 4-methylpentene, octene, diisobutylene and norbornene and derivatives thereof such as methyinorbornene and vinylnorbornene. In a further embodiment, the alkyl groups mentioned may be substituted by one or more hydroxyl groups.

Apart from ethylene, particularly preferred terpolymers contain from 0.1 to 12 mol %, in particular from 0.2 to 5 mol %, of vinyl neononanoate or of vinyl neodecanoate, and/or from 3.5 to 20 mol %, in particular from 8 to 15 mol %, of vinyl acetate, the total comonomer content being between 6 and 21 mol %, preferably between 12 and 18 mol %. Further particularly preferred copolymers contain, in addition to ethylene and from 8 to 18 mol % of vinyl esters, also from 0.5 to 15 mol % of alkenes, for example propene, butene, isobutylene, hexene, 4-methylpentene, octene, diisobutylene and/or norbornene.

Preference is given to using mixtures of two or more of the above-mentioned ethylene copolymers. More preferably, the polymers on which the mixtures are based differ in at least one characteristic. For example, they may contain different comonomers, different comonomer contents, molecular weights and/or degrees of branching.

The mixing ratio between the inventive additives and ethylene copolymers as constituent III may, depending on the application, vary within wide limits, the ethylene copolymers III often constituting the major proportion. Such additive mixtures preferably contain from 2 to 70% by weight, preferably from 5 to 50% by weight, of the inventive additive, and also from 30 to 98% by weight, preferably from 50 to 95% by weight, of ethylene copolymers.

In a further preferred embodiment, the inventive additives comprise oil-soluble polar nitrogen compounds.

The suitable oil-soluble polar nitrogen compounds (constituent IV) are preferably reaction products of fatty amines with compounds which contain an acyl group. The preferred amines are compounds of the formula NR⁶R⁷R⁸ where R⁶, R⁷ and R⁸ may be the same or different, and at least one of these groups is C₈-C₃₆-alkyl, C₆-C₃₆-cycloalkyl or C₈-C₃₆-alkenyl, in particular C₁₂-C₂₄-alkyl, C₁₂-C₂₄-alkenyl or cyclohexyl, and the remaining groups are either hydrogen, C₁-C₃₆-alkyl, C₂-C₃₆-alkenyl, cyclohexyl, or a group of the formulae -(A-O)ₓ-E or —(CH₂)ₙ—NYZ, where A is an ethyl or propyl group, x is a number from 1 to 50, E=H, C₁-C₃₀-alkyl, C₅-C₁₂-cycloalkyl or C₆-C₃₀-aryl, and n=2, 3 or 4, and Y and Z are each independently H, C₁-C₃₀-alkyl or -(A-O)ₓ. The alkyl and alkenyl radicals may each be linear or branched and contain up to two double bonds. They are preferably linear and substantially saturated, i.e. they have iodine numbers of less than 75 g of I₂/g, preferably less than 60 g of I₂/g and in particular between 1 and 10 g of I₂/g. Particular preference is given to secondary fatty amines in which two of the R⁶, R⁷ and R⁸ groups are each C₈-C₃₆-alkyl, C₆-C₃₆-cycloalkyl, C₈-C₃₆-alkenyl, in particular C₁₂-C₂₄-alkyl, C₁₂-C₂₄-alkenyl or cyclohexyl. Suitable fatty amines are, for example, octylamine, decylamine, dodecylamine, tetradecylamine, hexadecylamine, octadecylamine, eicosylamine, behenylamine, didecylamine, didodecylamine, ditetradecylamine, dihexadecylamine, dioctadecylamine, dieicosylamine, dibehenylamine and mixtures thereof. The amines especially contain chain cuts based on natural raw materials, for example coconut fatty amine, tallow fatty amine, hydrogenated tallow fatty amine, dicoconut fatty amine, ditallow fatty amine and di(hydrogenated tallow fatty amine). Particularly preferred amine derivatives are amine salts, imides and/or amides, for example amide-ammonium salts of secondary fatty amines, in particular of dicoconut fatty amine, ditallow fatty amine and distearylamine.

Acyl group refers here to a functional group of the following formula:
>C═O

Carbonyl compounds suitable for the reaction with amines are either low molecular weight or polymeric compounds having one or more carboxyl groups. Preference is given to those low molecular weight carbonyl compounds having 2, 3 or 4 carbonyl groups. They may also contain heteroatoms such as oxygen, sulfur and nitrogen. Suitable carboxylic acids are, for example, maleic acid, fumaric acid, crotonic acid, itaconic acid, succinic acid, C₁-C₄₀-alkenylsuccinic acid, adipic acid, glutaric acid, sebacic acid and malonic acid, and also benzoic acid, phthalic acid, trimellitic acid and pyromellitic acid, nitrilotriacetic acid, ethylenediaminetetraacetic acid and their reactive derivatives, for example esters, anhydrides and acid halides. Useful polymeric carbonyl compounds have been found to be in particular copolymers of ethylenically unsaturated acids, for example acrylic acid, methacrylic acid, maleic acid, fumaric acid and itaconic acid; particular preference is given to copolymers of maleic anhydride. Suitable comonomers are those which confer oil solubility on the copolymer. Oil-soluble means here that the copolymer, after reaction with the fatty amine, dissolves without residue in the middle distillate to be additized in practically relevant dosages. Suitable comonomers are, for example, olefins, alkyl esters of acrylic acid and methacrylic acid, alkyl vinyl esters, alkyl vinyl ethers having from 2 to 75, preferably from 4 to 40 and in particular from 8 to 20, carbon atoms in the alkyl radical. In the case of olefins, the alkyl radical attached to the double bond is equivalent here. The molecular weights of the polymeric carbonyl compounds are preferably between 400 and 20 000, more preferably between 500 and 10 000, for example between 1000 and 5000.

It has been found that oil-soluble polar nitrogen compounds which are obtained by reaction of aliphatic or aromatic amines, preferably long-chain aliphatic amines, with aliphatic or aromatic mono-, di-, tri- or tetracarboxylic acids or their anhydrides are particularly useful (cf. U.S. Pat. No. 4,211,534). Equally suitable as oil-soluble polar nitrogen compounds are amides and ammonium salts of aminoalkylenepolycarboxylic acids such as nitrilotriacetic acid or ethylenediaminetetraacetic acid with secondary amines (cf. EP 0 398 101). Other oil-soluble polar nitrogen compounds are copolymers of maleic anhydride and α,β-unsaturated compounds which may optionally be reacted with primary monoalkylamines and/or aliphatic alcohols (cf. EP-A-0 154 177, EP 0 777 712), the reaction products of alkenyl-spiro-bislactones with amines (cf. EP-A-0 413 279 B1) and, according to EP-A-0 606055 A2, reaction products of terpolymers based on α,β-unsaturated dicarboxylic anhydrides, α,β-unsaturated compounds and polyoxyalkylene ethers of lower unsaturated alcohols.

The mixing ratio between the inventive additives and oil-soluble polar nitrogen compounds as constituent IV may vary depending upon the application. Such additive mixtures preferably contain from 10 to 90% by weight, preferably from 20 to 80% by weight, of the inventive additive, and from 10 to 90% by weight, preferably from 20 to 80% by weight, of oil-soluble polar nitrogen compounds.

In a further preferred embodiment, the inventive additives comprise comb polymers.

Suitable comb polymers as a coadditive for the inventive additive (constituent V) may be described, for example, by the formula

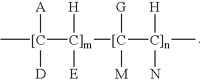

In this formula
A is R′, COOR′, OCOR′, R″—COOR′, OR′;
D is H, CH₃, A or R″;
E is H, A;
G is H, R″, R″—COOR′, an aryl radical or a heterocyclic radical;
M is H, COOR″, OCOR″, OR″, COOH;
N is H, R″, COOR″, OCOR, an aryl radical;
R′ is a hydrocarbon chain having from 8 to 50 carbon atoms;
R″ is a hydrocarbon chain having from 1 to 10 carbon atoms;
m is between 0.4 and 1.0; and

n is between 0 and 0.6.

In a further preferred embodiment, the inventive additives comprise polyoxyalkylene compounds.

Suitable polyoxyalkylene compounds as a coadditive for the inventive additive (constituent VI) are, for example, esters, ethers and ether/esters which bear at least one alkyl radical having from 12 to 30 carbon atoms. When the alkyl groups stem from an acid, the remainder stems from a polyhydric alcohol; when the alkyl radicals come from a fatty alcohol, the remainder of the compound stems from a polyacid.

Suitable polyols are polyethylene glycols, polypropylene glycols, polybutylene glycols and copolymers thereof having a molecular weight of from approx. 100 to approx. 5000, preferably from 200 to 2000. Also suitable are alkoxylates of polyols, for example of glycerol, trimethylol-propane, pentaerythritol, neopentyl glycol, and the oligomers which are obtainable therefrom by condensation and have from 2 to 10 monomer units, for example polyglycerol. Preferred alkoxylates are those having from 1 to 100 mol, in particular from 5 to 50 mol, of ethylene oxide, propylene oxide and/or butylene oxide per mole of polyol. Esters are particularly preferred.

Fatty acids having from 12 to 26 carbon atoms are preferred for the reaction with the polyols to form the ester additives, and particular preference is given to using C₁₈- to C₂₄-fatty acids, especially stearic and behenic acid. The esters may also be prepared by esterifying polyoxyalkylated alcohols. Preference is given to fully esterified polyoxyalkylated polyols having molecular weights of from 150 to 2000, preferably from 200 to 600. Particularly suitable are PEG-600 dibehenate and glycerol ethylene glycol tribehenate.

In a further preferred embodiment, the inventive additives comprise olefin copolymers.

Suitable olefin copolymers as a coadditive for the inventive additive (constituent VIII) may derive directly from monoethylenically unsaturated monomers, or may be prepared indirectly by hydrogenation of polymers which derive from polyunsaturated monomers such as isoprene or butadiene. Preferred copolymers contain, in addition to ethylene, structural units which derive from α-olefins having from 3 to 24 carbon atoms and have molecular weights of up to 120 000 g/mol. Preferred α-olefins are propylene, butene, isobutene, n-hexene, isohexene, n-octene, isooctene, n-decene, isodecene. The comonomer content of olefins is preferably between 15 and 50 mol %, more preferably between 20 and 35 mol % and especially between 30 and 45 mol %. These copolymers may also contain small amounts, for example up to 10 mol %, of further comonomers, for example nonterminal olefins or nonconjugated olefins. Preference is given to ethylene-propylene copolymers. The olefin copolymers may be prepared by known methods, for example by means of Ziegler or metallocene catalysts.

Further suitable olefin copolymers are block copolymers which contain blocks composed of olefinically unsaturated aromatic monomers A and blocks composed of hydrogenated polyolefins B. Particularly suitable block copolymers have the structure (AB)ₙA and (AB)ₘ, where n is between 1 and 10 and m is between 2 and 10.

The mixing ratio between the inventive additive composed of the graft copolymers and the further constituents V, VI and VII is generally in each case between 1:10 and 10:1, preferably in each case between 1:5 and 5:1, it being possible for one or two or all constituent(s) V, VI and VII to be present.

In a further preferred embodiment of the invention, the inventive additive (constituent I) is used in a mixture with one or alkylphenol resins according to constituent II and one or more ethylene copolymers according to constituent III. The mixing ratio of constituents I:II:III by weight is preferably 1:(0.1 to 10):(0.1 to 10), in particular 1:(0.2 to 2):(0.5 to 8).

The invention also relates to a fuel oil which comprises the aforementioned combination of constituents I, II and III, so that constituent I is present in an amount of from 10 to 500 ppm, and constituents I and III in the amounts which arise from their mixing ratio with constituent I in the additive used.

The additives may be used alone or else together with other additives, for example with other pour point depressants or dewaxing assistants, with antioxidants, cetane number improvers, dehazers, demulsifiers, detergents, lubricity additives, dispersants, antifoams, dyes, corrosion inhibitors, sludge inhibitors, odorants and/or additives for lowering the cloud point.

The inventive additives are suitable for improving the cold flow properties of fuel oils of animal, vegetable or mineral origin.

In addition, they disperse the paraffins which precipitate out below the cloud point in middle distillates. In particular, they are superior to the prior art additives in problematic oils having a low aromatics content of less than 25% by weight, in particular less than 22% by weight, for example less than 20% by weight, of aromatics, and thus lower solubility for n-paraffins. Middle distillates refer in particular to those mineral oils which are obtained by distillation of crude oil and boil in the range from 120 to 450° C., for example kerosene, jet fuel, diesel and heating oil. Aromatic compounds refer to the totality of mono-, di- and polycyclic aromatic compounds, as can be determined by means of HPLC to DIN EN 12916 (2001 edition). The inventive additives are particularly advantageous in those middle distillates which contain less than 350 ppm of sulfur, more preferably less than 100 ppm of sulfur, in particular less than 50 ppm of sulfur and in special cases less than 10 ppm of sulfur. They are generally those middle distillates which have been subjected to refining under hydrogenating conditions and therefore contain only small fractions of polyaromatic and polar compounds. They are preferably those middle distillates which have 90% distillation points below 360° C., in particular 350° C. and in special cases below 340° C.

In view of decreasing world mineral oil reserves and the discussion about the environmentally damaging consequences of the use of fossil and mineral fuels, there is increasing interest in alternative energy sources based on renewable raw materials. These include in particular native oils and fats of vegetable or animal origin. These are generally triglycerides of fatty acids having from 10 to 24 carbon atoms and a calorific value comparable to conventional fuels, but are at the same time classified as biodegradable and environmentally compatible.

Oils obtained from animal or vegetable material are mainly metabolism products which include triglycerides of monocarboxylic acids, for example acids having from 10 to 25 carbon atoms, and corresponding to the formula 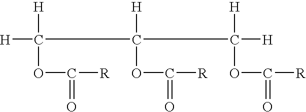
where R is an aliphatic radical which has from 10 to 25 carbon atoms and may be saturated or unsaturated.

In general, such oils contain glycerides from a series of acids whose number and type vary with the source of the oil, and they may additionally contain phosphoglycerides. Such oils can be obtained by processes known from the prior art.

As a consequence of the sometimes unsatisfactory physical properties of the triglycerides, the industry has applied itself to converting the naturally occurring triglycerides to fatty acid esters of low alcohols such as methanol or ethanol. The prior art also includes mixtures of middle distillates with oils of vegetable or animal origin (also referred to hereinbelow as “biofuel oils”).

In a preferred embodiment, the biofuel oil, which is frequently also referred to as biodiesel or biofuel, comprises fatty acid alkyl esters composed of fatty acids having from 12 to 24 carbon atoms and alcohols having from 1 to 4 carbon atoms. Typically, a relatively large portion of the fatty acids contains one, two or three double bonds. The biofuel is more preferably,-for example, rapeseed oil methyl ester and especially mixtures which comprise rapeseed oil fatty acid methyl ester, sunflower oil fatty acid methyl ester, palm oil fatty acid methyl ester, used oil fatty acid methyl ester and/or soya oil fatty acid methyl ester.

Examples of oils which are derived from animal or vegetable material and which can be used in the inventive composition are rapeseed oil, coriander oil, soya oil, cottonseed oil, sunflower oil, castor oil, olive oil, peanut oil, maize oil, almond oil, palm kernel oil, coconut oil, mustardseed oil, bovine tallow, bone oil and fish oils. Further examples include oils which are derived from wheat, jute, sesame, shea tree nut, arachis oil and linseed oil, and can be derived therefrom by processes known from the prior art. It is also possible to use oils which have been obtained from used oils such as deep fat fryer oil. Preference is given to rapeseed oil, which is a mixture of fatty acids partially esterified with glycerol, since it is obtainable in large amounts and is obtainable in a simple manner by extractive pressing of rapeseeds. In addition, preference is given to the likewise widely available oils of sunflowers and soya, and also to their mixtures with rapeseed oil.

Useful lower alkyl esters of fatty acids are the following, for example as commercial mixtures: the ethyl, propyl, butyl and in particular methyl esters of fatty acids having from 12 to 22 carbon atoms, for example of lauric acid, myristic acid, palmitic acid, palmitolic acid, stearic acid, oleic acid, elaidic acid, petroselic acid, ricinolic acid, elaeostearic acid, linoleic acid, linolenic acid, eicosanoic acid, gadoleic acid, docosanoic acid or erucic acid, each of which preferably has an iodine number of from 50 to 150, in particular from 90 to 125. Mixtures having particularly advantageous properties are those which comprise mainly, i.e. comprise at least 50% by weight of, methyl esters of fatty acids having from 16 to 22 carbon atoms, and 1, 2 or 3 double bonds. The preferred lower alkyl esters of fatty acids are the methyl esters of oleic acid, linoleic acid, linolenic acid and erucic acid.

Commercial mixtures of the type mentioned are obtained, for example, by hydrolyzing and esterifying or by transesterifying animal and vegetable fats and oils, by transesterifying them with lower aliphatic alcohols. To prepare lower alkyl esters of fatty acids, it is advantageous to start from fats and oils having a high iodine number, for example sunflower oil, rapeseed oil, coriander oil, castor oil, soya oil, cottonseed oil, peanut oil or bovine tallow. Preference is given to lower alkyl esters of fatty acids based on a novel type of rapeseed oil, whose fatty acid component is derived to an extent of more than 80% by weight from unsaturated fatty acids having 18 carbon atoms.

When mixtures of middle distillate of mineral origin (A) and biofuels (B) are used, the A:B mixing ratio of the constituents may vary as desired. It is preferably between A:B=99.9:0.1 and 0.1:99.9, in particular from 99:1 to 1:99, especially from 95:5 to 5:95, for example from 85:15 to 15:85 or from 80:20 to 20:80.

It is also possible to use mixtures of synthetic fuels, as are obtainable, for example, from the Fischer-Tropsch process, and a middle distillate of mineral origin A and/or a biofuel B as the fuel oil composition.

### EXAMPLES

TABLE 1
Characterization of the test oils:

| Distillation | | | Test oil 1 | Test oil 2 | Test oil 3 | Test oil 4 | Test oil 5 |
|---|---|---|---|---|---|---|---|
| IBP | | [° C.] | 166.3° C. | 173.8° C. | 240.7 | 173.8 | 166.6 |
| 90% − 20% cut | | [° C.] | 147° C. | 117° C. | 64.4 | 116.6 | 102.5 |
| FBP | | [° C.] | 377.9° C. | 345.7° C. | 345.7 | 352.6 | 359.4 |
| Cloud Point | | [° C.] | −8.0 | −6.7 | −8.2 | −6.9 | −3.9 |
| CFPP | | [° C.] | −11.0 | −8.0 | −11 | −9 | −7 |
| Sulfur | | [ppm] | 308 | 210 | 1450 | 320 | 2.7 |
| Density @15° C. | | [g/cm³] | 0.826 | 0.831 | 0.841 | 0.827 | 0.845 |
| Aromatics content | | [% by wt.] | 18.73 | 27.50 | 24.16 | 27.96 | 26.63 |
| of which | mono | [% by wt.] | 14.31 | 22.22 | 15.76 | 22.58 | 23.89 |
| | di | [% by wt.] | 3.93 | 4.83 | 7.93 | 4.91 | 2.54 |
| | poly | [% by wt.] | 0.49 | 0.46 | 0.47 | 0.48 | 0.19 |

The test oils employed were current oils from European refineries. The CFPP value was determined to EN 116 and the cloud point to ISO 3015. The aromatic hydrocarbon groups were determined to DIN EN 12916 (November 2001 edition).

The following additives were used:

Characterization of the ethylene copolymers used as flow improvers (constituent III)

The ethylene copolymers used were commercial products having the properties reported in Table 2. The products were used in the form of 65% and 50% dilutions in kerosene.

The viscosity was determined to ISO 3219/B with a rotational viscometer (Haake RV20) with plate-cone measuring system at 140° C.

TABLE 2
Characterization of the ethylene copolymers used (constituent III)

| Example | Comonomer(s) | V₁₄₀ | CH₃/100 CH₂ |
|---|---|---|---|
| A1 | 13.6 mol % of vinyl acetate | 130 mPas | 3.7 |
| A2 | 14.5 mol % of vinyl acetate and | 105 mPas | 5.3 |
| | 1.4 mol % of vinyl neodecanoate | | |
| A3 | 11.2 mol % of vinyl acetate | 220 mPas | 6.2 |

Characterization of the alkylphenol-aldehyde resins used (constituent II):
B1) nonylphenol-formaldehyde resin, Mw 2000 g/mol
B2) dodecylphenol-formaldehyde resin, Mw 4000 g/mol

B3) C_{20/24} alkylphenol-formaldehyde resin, Mw 3000 g/mol

TABLE 3
Characterization of the graft copolymers with acrylates.

| Example | Base polymer | Acrylic ester | K value |
|---|---|---|---|
| 1 (C) | Ethylene-vinyl acetate with 11.2 | Tetradodecyl | 23.8 |
| | mol % of vinyl acetate | acrylate | |
| 2 (C) | Ethylene-vinyl acetate-propylene | Tetradodecyl | 20.8 |
| | with 14 mol % of vinyl acetate | acrylate | |
| | and 11 mol % of propylene | | |
| 3 | Ethylene-vinyl acetate-vinyl | Tetradodecyl | 19.9 |
| | neodecanoate with 14 mol % of | acrylate | |
| | vinyl acetate and 1.6 mol % of | | |
| | vinyl neodecanoate | | |
| 4 | Ethylene-vinyl acetate-vinyl | Behenyldodecyl | 24.3 |
| | neodecanoate with 14 mol % of | acrylate | |
| | vinyl acetate and 1.6 mol % of | | |
| | vinyl neodecanoate | | |

The K values reported were measured according to Ubbelohde in 5% by weight solution in toluene at 25° C.

“Tetradodecyl” represents a mixture of tetradecyl and dodecyl “Behenyidodecyl” represents a mixture of behenyl and dodecyl

TABLE 4
Characterization of the graft copolymers
with methacrylates (comparison)

| | | Methacrylic | |
|---|---|---|---|
| Example | Base polymer | ester | K value |
| 5 (C) | Ethylene-vinyl acetate with 13.3 | Tetradodecyl | 24.5 |
| | mol % of vinyl acetate | methacrylate | |
| 6 (C) | Ethylene-vinyl acetate with 13.3 | Behenyldodecyl | 24.9 |
| | mol % of vinyl acetate | methacrylate | |

The K values reported were measured according to Ubbelohde in 5% by weight solution in toluene at 25° C.

Effectiveness of the additives as cold flow improvers

To assess the effect of the inventive additives on the cold flow properties of middle distillates, the inventive additives were tested in middle distillates as follows in the short sediment test:

150 ml of the middle distillates admixed with the additive components specified in the table were cooled in 200 ml measuring cylinders in a cold cabinet at −2° C./hour to −13° C. and stored at this temperature for 16 hours. Subsequently, volume and appearance, both of the sedimented paraffin phase and of the oil phase above it, were determined and assessed visually. A small amount of sediment and an opaque oil phase show good paraffin dispersancy.

In addition, the lower 20% by volume is isolated and the cloud point is determined to ISO 3015. Only a slight deviation of the cloud point of the lower phase (CP_{cc}) from the blank value of the oil shows good paraffin dispersancy.

The graft copolymers reported are used in an amount of 100-150 ppm. A dispersant is used generally in the presence of a cold flow improver. In addition to the graft polymer, appropriate cold flow improvers were therefore used.

Results in Test Oil 1

The CFPP effectiveness and dispersing action of the inventive graft polymers (constituent I) were determined in a composition of (by parts by weight) 3:0.5:1 of constituents III:II:I.

Alkylphenol-aldehyde resin: (constituent II): B1

Flow improver (constituent III): A1

TABLE 5

| | Graft | | | |
|---|---|---|---|---|
| | copolymer | CFPP | CP_{cc} | Visual |
| Example | of Example | [° C.] | [° C.] | assessment |
| 7 (C) | 1 | −22 | −7.4 | Homogeneously |
| | | | | opaque, |
| | | | | no sediment |
| 8 (C) | 2 | −22 | −7.1 | Homogeneously |
| | | | | opaque, 1 ml |
| | | | | of sediment |
| 9 | 3 | −23 | −7.4 | Homogeneously |
| | | | | opaque, |
| | | | | no sediment |
| 10 | 4 | −24 | −7.7 | Homogeneously |
| | | | | opaque, |
| | | | | no sediment |

Results in Test Oil 2

The CFPP effectiveness and dispersing action of the inventive graft polymers (constituent I) were determined in a composition of (by parts by weight) 3:0.5:1 of constituents III:II:I.

Alkylphenol-aldehyde resin: (constituent II): B2

Flow improver (constituent III): mixture of 1 0% A1 and 25% A2

TABLE 6

| | Graft | | | |
|---|---|---|---|---|
| | copolymer | CFPP | CP_{cc} | Visual |
| Example | of Example | [° C.] | [° C.] | assessment |
| 11 (C) | 1 | −22 | −6.4 | Homogeneously |
| | | | | opaque, no |
| | | | | sediment |
| 12 (C) | 2 | −22 | −5.1 | Homogeneously |
| | | | | opaque, 2 ml |
| | | | | of sediment |
| 13 | 3 | −24 | −5.2 | Homogeneously |
| | | | | opaque, 2 ml |
| | | | | of sediment |
| 14 | 4 | −28 | −6.2 | Homogeneously |
| | | | | opaque, no |
| | | | | sediment |
| 15 (C) | 5 | −21 | −4.6 | 10 ml of |
| | | | | sediment, |
| | | | | remainder clear |
| 16 (C) | 6 | −22 | −5.0 | 10 ml of |
| | | | | sediment, |
| | | | | remainder clear |

Results in Test Oil 3

The CFPP effectiveness and dispersing action of the inventive graft polymers (constituent I) were determined in a composition of (by parts by weight) 4:0.5:1 of constituents III:II:I.

Alkylphenol-aldehyde resin: (constituent II): B1

Flow improver (constituent III): mixture of 10% A2 and 15% A3

TABLE 7

| | Graft | | | |
|---|---|---|---|---|
| | copolymer | CFPP | CP_{cc} | Visual |
| Example | of Example | [° C.] | [° C.] | assessment |
| 17 (C) | 1 | −20 | −7.9 | Homogeneously |
| | | | | opaque, |
| | | | | no sediment |
| 18 (C) | 2 | −20 | −8.1 | Homogeneously |
| | | | | opaque, |
| | | | | no sediment |
| 19 | 3 | −23 | −7.7 | Homogeneously |
| | | | | opaque, 2 ml |
| | | | | of sediment |
| 20 | 4 | −24 | −8.0 | Homogeneously |
| | | | | opaque, |
| | | | | no sediment |
| 21 (C) | 5 | −19 | −6.1 | 18 ml of |
| | | | | sediment, |
| | | | | remainder clear |
| 22 (C) | 6 | −18 | −3.0 | 20 ml of |
| | | | | sediment, |
| | | | | remainder clear |

Results in Test Oil 4

The CFPP effectiveness and dispersing action of the inventive graft polymers (constituent I) were determined in a composition of (by parts by weight) 3:0.5:1 of constituents III:II:I.

Alkylphenol-aldehyde resin: (constituent II): B1

Flow improver (constituent III): A3

TABLE 8

| | Graft | | | |
|---|---|---|---|---|
| | copolymer | CFPP | CP_{cc} | Visual |
| Example | of Example | [° C.] | [° C.] | assessment |
| 23 (C) | 2 | −20 | −6.6 | Homogeneously |
| | | | | opaque, |
| | | | | no sediment |
| 24 | 3 | −22 | −6.0 | Homogeneously |
| | | | | opaque, |
| | | | | no sediment |
| 25 | 4 | −21 | −6.1 | Homogeneously |
| | | | | opaque, |
| | | | | no sediment |
| 26 (C) | 5 | −24 | −5.1 | 15 ml of |
| | | | | sediment, |
| | | | | remainder clear |
| 27 (C) | 6 | −24 | −4.1 | 20 ml of |
| | | | | sediment, |
| | | | | remainder clear |

Results in Test Oil 5

The CFPP effectiveness and dispersing action of the inventive graft polymers (constituent I) were determined in a composition of (by parts by weight) 4:0.5:1 of constituents III:II:I.

Alkylphenol-aldehyde resin: (constituent II): B1

Flow improver (constituent III): A2

TABLE 9

| | Graft | | | |
|---|---|---|---|---|
| | copolymer | CFPP | CP_{cc} | Visual |
| Example | of Example | [° C.] | [° C.] | assessment |
| 28 (C) | 1 | −24 | −6.9 | Homogeneously |
| | | | | opaque, |
| | | | | no sediment |
| 29 (C) | 2 | −22 | −7.1 | Homogeneously |
| | | | | opaque, |
| | | | | no sediment |
| 30 | 3 | −25 | −7.5 | Homogeneously |
| | | | | opaque, |
| | | | | no sediment |

1. A graft copolymer obtained by grafting an ester (a) of a C₈- to C₂₂-alcohol and acrylic acid onto a copolymer (b) having, in addition to ethylene, from 3.5 to 21 mol % of vinyl acetate and from 0.5 to 16 mol % of at least one vinyl ester of the formula 1
CH₂═CH—OCOR¹ (1)
where R¹ is C₂- to C₃₀-alkyl, with the proviso that the copolymer b) contains less than 0.5 mol % of alkenes having 3 to 30 carbon atoms.

2. A graft copolymer as claimed in claim 1, which has a molecular weight (Mn) of from 1000 to 10 000 g/mol.

3. A graft copolymer as claimed in claim 1, which has a molecular weight distribution M_{w}/Mₙ of 1-10.

4. A graft copolymer as claimed in claim 1, which has been prepared from a copolymer b) which has from 7.5 to 15 mol % of vinyl acetate.

5. A graft copolymer as claimed in claim 1, which has been prepared from a copolymer b) which has from 1 to 16 mol % of further olefinically unsaturated monomer apart from alkenes having from 3 to 30 carbon atoms.

6. A graft copolymer as claimed in claim 5, wherein the olefinically unsaturated monomer is selected from the group consisting of vinyl ester, acrylic ester, methacrylic ester, alkyl vinyl ether, and mixtures thereof.

7. A graft copolymer of claim 1, which has a weight ratio of graft component a) to copolymer b) of from 4:1 to 1:4.

8. A composition comprising the graft copolymer of claim 1 and a further copolymer which, apart from ethylene, contains from 3.5 to 20 mol % of a vinyl ester of a C₂ to C₄ carboxylic acid and from 0.1 to 12 mol % of a C₆ to C₁₂ carboxylic acid, the total content of vinyl ester being from 6 to 21 mol %.

9. The composition as claimed in claim 8, in which the further copolymer, apart from ethylene, contains from 3.5 to 20 mol % of vinyl acetate and/or from 0.1 to 12 mol % of vinyl neononanoate or vinyl neodecanoate, the total comonomer content being between 6 and 21 mol %.

10. A composition comprising the graft copolymer of claim 1 and a further copolymer which, in addition to ethylene and from 8 to 18 mol % of vinyl esters, also has from 0.5 to 15 mol % of an olefin selected from propene, butene, isobutylene, hexene, 4-methylpentene, octene, diisobutylene, norbornene, and mixtures thereof.

11. The composition of claim 8, in which the further copolymer has a melt viscosity between 20 and 10 000 mpas.

12. The composition of claim 1, further comprising at least one alkylphenol-formaldehyde resin of the formula 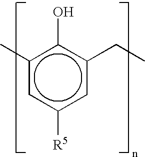
in which R⁵ is C₄-C₃₀-alkyl or -alkenyl and n is from 2 to 50.

13. The composition of claim 1, further comprising at least one amine salt, imide or amide of a primary or a secondary fatty amine or a mixture thereof having 8 to 36 carbon atoms.

14. The composition of claim 1, further comprising at least one copolymer which is derived from an amide, an imide amides, or an ester of maleic acid or mixtures thereof, fumaric acid or itaconic acid or mixtures thereof.

15. The composition of claim 1, further comprising a comb polymer of the formula 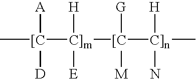
in which
A is R′, COOR′, OCOR′, R″—COOR′ or OR′;
D is H, CH₃, A or R;
E is H or A;
G is H, R″, R″—COOR′, an aryl radical or a heterocyclic radical;
M is H, COOR″, OCOR″, OR″ or COOH;
N is H, R″, COOR″, OCOR, COOH or an aryl radical;
R¹ is a hydrocarbon chain having 8-150 carbon atoms;
R″ is a hydrocarbon chain having 1 to 10 carbon atoms;
m is between 0.4 and 1.0; and
n is between 0 and 0.6.

16. A fuel oil composition F comprising
F1 a fuel oil of mineral origin, or
F2 a fuel oil of animal or vegetable origin or a mixture thereof or
F3 a fuel oil prepared by the Fischer-Tropsch process or any mixture of F1, F2, and F3, and
an additive comprising the composition of claim 8.

17. The fuel oil composition as claimed in claim 16, wherein F2 comprises one or more esters of a monocarboxylic acid having 12 to 24 carbon atoms and an alcohol having from 1 to 4 carbon atoms.

18. The fuel oil composition as claimed in claim 17, in which the alcohol is methanol or ethanol.

19. The fuel oil composition of claim 16, in which the constituent F2 contains more than 5% by weight of esters of saturated fatty acids.

20. The fuel oil composition of claim 16, in which the constituent F2 is present to an extent of more than 2% by volume.

21. The fuel oil composition of claim 16, in which the constituent F3 is present to an extent of more than 2% by volume.

22. A method for improving the cold flow properties and paraffin dispersancy of a fuel oil, said method comprising adding the graft copolymer of claim 1 to the fuel oil.
